(19) United States
(12) Patent Application Publication
(10) Pub. No.: US 2023/0344096 A1
(43) Pub. Date: Oct. 26, 2023

(54) ENERGY STORAGE CELL

(71) Applicant: Tesla, Inc., Austin, TX (US)

(72) Inventors: Andrew Pires, San Francisco, CA (US); Jayesh Bharat Gorasia, San Francisco, CA (US); Cole Prodan, Mountain View, CA (US)

(21) Appl. No.: 18/026,432

(22) PCT Filed: Sep. 21, 2021
(86) PCT No.: PCT/US2021/051343

§ 371 Date: Mar. 15, 2023

Related U.S. Application Data
(60) Provisional application No. 63/081,238, filed on Sep. 21, 2020.

(51) Int. Cl. H01M 50/559; H01M 50/342; H01M 50/213

(52) U.S. Cl. CPC H01M 50/559; H01M 50/3425; H01M 50/213

(57) ABSTRACT

A system for incorporating one or more individual energy cells is provided. Individual energy cells include a top surface having a center terminal and an outer terminal. The first terminal and the second terminal are configured as substantially planar electrical contacts. The cell further includes a side surface mechanically connected to the top surface and a bottom surface mechanically connected to the side surface.

### CROSS-REFERENCE TO RELATED APPLICATION

This application claims the benefit of U.S. Provisional Application No. 63/081,238, entitled “ENERGY STORAGE CELL”, and filed on Sep. 21, 2020. U.S. Provisional Application No. 63/081,238 is incorporated by reference herein.

### BACKGROUND

Generally described, a number of devices or components may be powered, at least in part, by an electric power source. In the context of vehicles, electric vehicles may be powered, in whole or in part, by a power source. The power source for an electric vehicle may be generally referred to as a “battery,” which can represent individual battery cells or cells, modules and packs. In some approaches, a cluster of cells can be considered as individual modules and a cluster of modules can be considered a pack. The power sources for electric vehicles can be installed and maintained in a pack configuration. Similar approaches/terminology can apply to grid storage application for collecting, storing and distributing energy.

Electric vehicles typically require a large multiple of power—a thousand times stronger than that of a typical consumer product, such as a mobile device. To achieve these power requirements, the battery pack of electric vehicles typically include a large, dense arrangement of individual cells, individually placed or configured into a plurality of modules. The composition and performance of the battery pack will depend on the characteristics of the individual battery cells, the total number of individual cells that are incorporated into the battery pack, and configurations/orientations of the cells and ancillary components into modules or the battery pack. The battery pack may represent one of the most expensive and massive assemblies in the context of most electric vehicle transportation and grid storage applications.

### SUMMARY

The present disclosure provides an energy cell comprising a circular top surface having a center terminal, an outer terminal, and a terminal insulator gasket, wherein the center terminal and the outer terminal are configured as electrical contacts, wherein the center terminal is encircled by the outer terminal, wherein the center terminal and the outer terminal substantially cover the top surface, wherein the center terminal and the outer terminal are separated by the terminal insulator gasket, wherein the terminal insulator gasket is a electrical insulator; a side surface mechanically connected to the top surface; a circular bottom surface mechanically connected to the side surface having a annular interface and a pressure venting feature, wherein, the annular interface configured to form a base for the cell, wherein the pressure venting feature is configured for venting in an opposite direction of the top surface; and an energy storage material within the top surface, the side surface, and the bottom surface. The top surface and the side surface can be contiguous. An area of the center terminal 202 and an area of the outer terminal can be configured to be dependent. An area of the center terminal 202 and an area of the outer terminal can be determined based on a threshold of statistical likelihood that a cell array-level interconnect welding or other assembly process will be successful.

The present disclosure provides an energy cell comprising a top surface having a center terminal and an outer terminal, wherein the first terminal and the second terminal are configured as substantially planar electrical contacts; a side surface mechanically connected to the top surface; a bottom surface mechanically connected to the side surface; and an energy storage material within the top surface, the side surface, and the bottom surface. The top surface can be substantially circular. The center terminal and the outer terminal can substantially cover the top surface. The center terminal and the outer terminal can be separated by a terminal insulator gasket, wherein the terminal insulator gasket is an electrical insulator. The center terminal can be a cathode and the outer terminal can be an anode. An area of the center terminal and an area of the outer terminal can be configured to be dependent. An area of the center terminal and an area of the outer terminal can be determined based on a threshold of statistical likelihood that a cell array-level interconnect welding or other assembly process will be successful. The energy cell can further comprise a sleeve wherein the sleeve encompasses at least part of the side surface. The sleeve can be comprised of an electrically insulating material. The sleeve can be comprised of two layers of one or more materials. The top surface and the side surface can be contiguous. The top surface can be sufficiently ferrous to allow movement via magnetic adhesion by manufacturing equipment. The bottom surface can be substantially circular. The bottom surface can have an annular interface configured to form a base for the cell. The bottom surface can have a pressure venting feature configured for venting in an opposite direction of the top surface.

The present disclosure provides a battery system comprising a plurality of cells, wherein each of the cells includes: a top surface having a center terminal and an outer terminal, wherein the first terminal and the second terminal are configured as electrical contacts; a side surface mechanically connected to the top surface; a bottom surface mechanically connected to the side surface; and an energy storage material within the top surface, the side surface, and the bottom surface, wherein the cells are interconnected by laser welds and aligned in a substantially planar configuration.

### BRIEF DESCRIPTION OF THE DRAWINGS

These and other features, aspects, and advantages of the present disclosure are described with reference to the drawings of certain configurations, which are intended to schematically illustrate certain configurations and not to limit the disclosure.

FIG. 1A illustrates an example energy storage cell in a sleeve.

FIG. 1B illustrates a perspective view of an example energy storage cell.

FIG. 2A illustrates a top view of an example energy storage cell.

FIG. 2B illustrates an alternate top view of an example energy storage cell.

FIG. 3 illustrates a bottom view of an example energy cell.

FIG. 4 illustrates a side view structural diagram of the top surface and bottom surface of an example energy cell.

FIG. 5 illustrates an exploded view of an example energy storage system.

### DETAILED DESCRIPTION

Generally described, one or more aspects of the present disclosure relate to energy storage cells. More particularly, the present disclosure relates to an energy storage cell that is designed for integration into large-scale vehicle and grid storage products. Illustratively, to support such integration, individual energy storage cells can correspond to cylindrical shaped storage cells of various volumes and aspect ratios. The cylindrical storage cells have specific characteristics or configurations that further support integration. More specifically, in one aspect, the cylindrical storage cells include a top surface that is configured specifically to present concentric and substantially co-planar positive and negative terminals such that the surface area for welding interconnects offers statistically balanced outcomes between positive and negative terminals. In a related aspect, the center terminal interface (be it positive or negative) may be elevated relative to the surrounding geometry, including the other terminal, the terminal insulator gasket which serves as a electrical insulator between the two terminals, or another element of the cell canister. In another aspect, the cylindrical storage cells include a side surface that is sleeved to electrically isolate individual cells from each other and ancillary components in a cell array. Additionally, the side surface illustratively functions to interface with cooling systems added as part of the cell array, serving as the primary conduit for extracting heat generated within individual cells. In still another aspect, the cylindrical storage cell design includes a bottom surface that selectively groups cell features or functionalities that, in prior art, may require incorporation into either the top surface or side surface. Such additional features can include geometry for sealing of the open end of a drawn or extruded cell can, geometry for calibrated venting in thermal runaway, inputs for receiving material into the storage cell, and the like.

In an illustrative embodiment, the specific combination of above-described aspects of the top surface, side surface, and bottom surface of the cylindrical storage cell facilitates an increased optimization of the functions implemented by each respective surface. For example, by limiting the functionality or components presented on the top surface to the positive and negative terminal, the illustrative cylindrical storage cell can increase the surface area of the top surface corresponding to the positive and negative terminals and thereby facilitate welding of electrical interconnects via manufacturing processes, such as laser welding. This can improve economic and performance characteristics. In another example, the utilization of sleeve materials having additional temperature conducting properties enables the establishment of cost and performance-optimized cooling channels in a cell array embodiment. One skilled in the relevant art will appreciate that additional examples and benefits are also facilitated by such configurations or combinations. Additionally, one skilled in the relevant art will appreciate that other storage cell implementations within the scope of the present application may incorporate different combinations of aspects of the surfaces presented herein.

Various energy storage cell designs attempt to optimize cost, package volume, mass, performance, durability, and manufacturing efficiency at the individual cell level. However, such localized optimizations typically do not translate into system-level metric optimizations for energy storage systems into which the storage cells are integrated, for example with cell arrays utilized in electric vehicles or grid energy storage systems. Cell form factor selection offers efficient and effective leverage on the resulting performance, cost, package volume, durability, and manufacturing efficiency of a battery pack. Three distinct form factors are most typically used in large-scale product applications: pouch cells, prismatic cells, and cylindrical cells. The cylindrical format offers decisive benefits in cost/manufacturing efficiency, via single-piece continuous motion assembly processes, and packaging/durability, via internally resolved electrode stack material expansion forces. Cylindrical formats also generally yield improvements in performance, via shorter thermal path lengths, and volumetric energy density, via wrapped geometry of the electrode stack. One skilled in the relevant art will appreciate that in order to manifest aforementioned cylindrical format advantages at the level of an integrated battery pack, the materials and mechanical features of the individual cell, including the cell exterior, may impact the ability to integrate a plurality of cells to achieve functionality of the battery pack. Accordingly, specific feature and functionality configurations across various surfaces of individual cylindrical storage cells, as described herein, can provide additional product system-level optimizations of costs, package volume, mass, performance, durability, and manufacturing efficiencies for integrated cell arrays.

Although the present disclosure focuses on its use in energy storage systems, the cylindrical energy storage cell design may be utilized to improve any energy storage device of cylindrical form factor (batteries, capacitors, etc.) where automated manufacture of a cost, volume, performance and mass-sensitive large array product is a priority outcome. One skilled in the relevant art will appreciate additional advantages or technical efficiencies may be associated with one or more aspects of the present application or combinations of aspects without limitation.

### Illustrative Energy Storage Cell

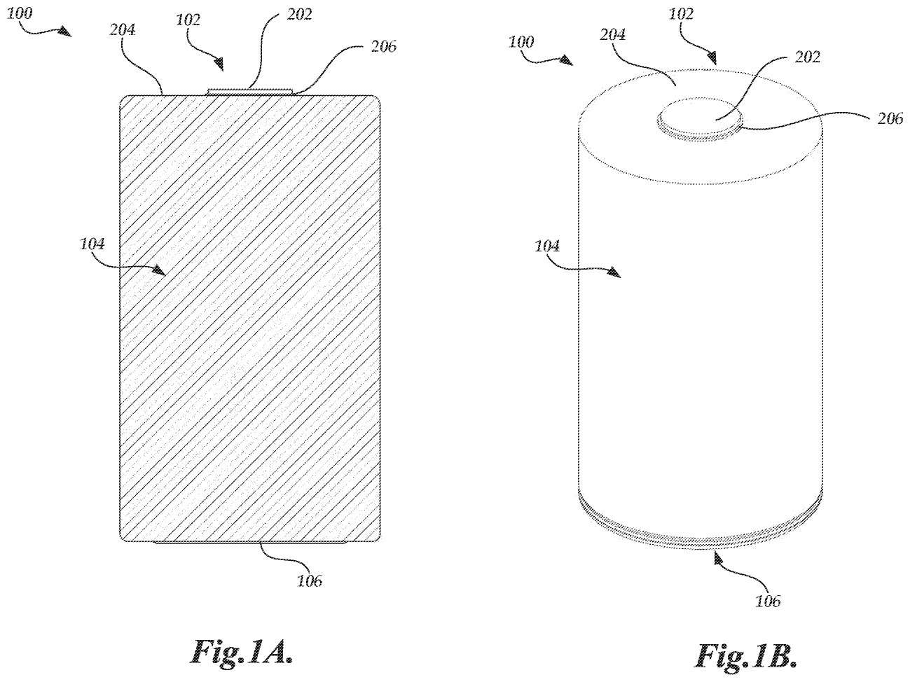

FIG. 1A shows a sectioned sideview of an illustrative cylindrical energy storage cell 100. The storage cell may have a top surface 102, a side surface 104, and a bottom surface 106. The side surface 104 may comprise the cell wall of the storage cell. Cell dimensions (such as height and diameter, and the like) may be optimized to form repeating pattern of same-voltage clusters across a variety of energy storage systems, such as, but not limited to, vehicle battery platforms and energy grid networks at various bus voltages. Materials used for construction of the storage cell may be chemically and thermally compatible with both internally and externally contacting substances in a given energy storage application. Although illustrated as a cylindrical-shaped embodiment in FIGS. 1A and 1B, in other embodiments, the energy storage cell may have non-cylindrical form, such as a prismatic or pouch form factor.

FIG. 1B shows a perspective view of an illustrative cylindrical energy storage cell. The side surface 104 can be part of a continuous structure forming the structure of the cell. The top surface 102 and the side surface 104 can be contiguous (for example, materially contiguous, mechanically contiguous, or any other form of contiguity or continuousness). Similarly, the bottom surface 106 and the side surface 104 can be contiguous. For example, the outer structure of a cell is often referred to as the “can,” and in which the side surface can be referred to as the “can wall.” Illustratively, the side surface 104 of the cell may be contiguous with the top surface 102 or the bottom surface 106 to reduce the number or severity of mechanical and electrical weak points on the cell. For example, in embodiments in which the side surface 104 is contiguous with the top surface 102, the cell presents a locally homogeneous structure in terms of stiffness and strength. Such a cell structure may be better suited for handling mechanical load, pressure, or stress that is applied, or otherwise experienced, at the top surface 102. This can also be advantageous for assembly of the cell or for assembly of a product in which the cell is used by, eliminating mechanical weaknesses and associated assembly errors.

Additionally, the top surface 102, as described below, can be used to handle part of the mechanical load, pressure, or stress applied to the top surface 102 once a cell is deployed for use. Illustratively, the top surface 102 can be configured for increased tensile strength and stiffness for product structure integration and compressive strength and stiffness to react fixturing forces during electrical interconnect processes. More specifically, the top surface 102 can be bonded directly to a sheet such that an array of cells 100 creates a sandwich panel structure that offers sufficient strength and stiffness to support its own mass, or additionally, a product frame (such as a vehicle body).

In some embodiments, a sleeve 108 can be applied to an outer surface of the storage cell 100. The sleeve can substantially encompass at least the cylindrical side surface 104 of the cell. Illustratively, the cylindrical side surface 104 is made up of an electrically conductive material. In some embodiments, the sleeve 108 does not substantially encompass the cylindrical side surface 104 of the cell, but rather can be comprised of one or more bands that partly expose the side surface 104 of the cell. These bands of the sleeve 108 can be spaced equidistance from each other along the height of the cylindrical side surface 104 of the cell or can be placed substantially close to the top surface 102 of the cell or the bottom surface 106 of the cell. When the sleeve 108 comprises one or more bands, the sleeve 108 enables electrically-isolated physical contact between cells and other components (including other cells), while maintaining opportunity for direct mechanical bonding to the side surface 104 of the cell.

In some embodiments, the sleeve 108 can be an electrically insulating material. The sleeve 108 may create an electrical barrier that electrically isolates each energy storage cell from other energy storage system components, such as a product frame, other storage cells, and cooling systems. The sleeve 108 may facilitate the construction or configuration a plurality of storage cells 100 corresponding to a series voltage string with maximum volumetric packing density of battery cells 100. In this configuration, the sleeve 108 mitigates undesired electrical connectivity between individual cells, allowing the cell array to eliminate spacing gaps between storage cells. Use of a sleeve may thus allow several benefits in energy storage systems, including, but not limited to, improving volumetric energy density, reducing internal void volume (which directly reduces cost for structurally-filled module and battery pack configurations), encouraging balanced distribution of thermal energy from provoked or unprovoked thermal runaway (which reduces likelihood of propagation to module or pack-level safety event), enforcing cell spacing as a bumper, buffer or mechanical shim between cells, and allowing neighboring components to be electrically or thermally conductive for application-specific performance improvement.

Alternatively, the sleeve 108 can be used as a bumper, buffer, or mechanical shim to physically enforce cell separation without itself serving as the primary electrically insulative medium. Using the sleeve 108 as a bumper or buffer to enforce cell spacing can reduce movement and pitch of the cell. In some embodiments, the sleeve 108 can be a label for the cell and include information about the cell such as regulatory information or important usage details.

In some embodiments, the sleeve 108 is a single wrapping of a material. In some embodiments, the sleeve 108 is a double wrapping of one or two materials. The double wrapping can be useful if key performance properties of one or both wrappings degrade over time. A double wrapping can further be useful for improved serviceability, by creating a sliding interface layer which simplifies cell removal from and replacement within a cell array.

In other embodiments, the storage cell 100 may be manufactured without the sleeve 108 such that the electrically conductive side surface is exposed. In such embodiment, during use in an energy storage system, then, the storage cells 100 may be arranged such that a distance remains between storage cells 100 and other components of the energy storage system. If distance between storage cells 100 is undesired in such an embodiment, the cells in adjacent same-voltage clusters may be configured with inverted terminal polarity such that direct contact between side surfaces 104 results in zero electrical potential, thereby rendering the contact inconsequential for constructing a series voltage stack.

With reference to FIG. 1B, the side surface 104 may be designed to facilitate air, liquid, or passive cooling along through a section of the side surface 104 where there exist no other competing functions. In some embodiments, the side surface 104 may interface with an active cooling channel or cooling component (for example, a heat sink) provided as part of the manufacturing of the cell array. Accordingly, the side surface 104 and sleeve 108 (individually or in combinate) may present to have a superior thermally conductive pathway as compared to one or both other surfaces of the storage cell 100. In some embodiments, the storage cell 100 may be cooled via the top surface 102 or bottom surface 106. Any subgroup of these interfaces could be cooled simultaneously, or all of them together (for example, immersion, phase-change, etc.), or not cooled at all (passive/rely on thermal capacity of the cell). In some embodiments, the side surface 104 can be swept cylindrically around the cell. In some embodiments, the side surface 104 can be curved near the top surface 102 or the bottom surface 106. Cooling the side surface 104 can be used alternatively to cooling the top surface 102 and the bottom surface 104. This in turn can allow for the design of the top surface 102 and the bottom surface 106 to be primarily designed for pressure venting, electrical terminal cell functions, and structural connections. Cooling the side surface 104 can also be advantageous for maximizing cell canister height which can be packaged in a fixed vehicle product height envelope, in effect, minimizing cell active material cost/mass overheads. Such a cooling arrangement also enables removal of thermal management interfaces from typical abuse zones in the series load path for a structurally integrated energy storage system. This configuration can offer additional thermal benefits, for example by minimizing rate of heat leak to ambient environment such that the cells provide thermal storage for warming a vehicle cabin. In embodiments where the side surface 104 is cooled, the sleeve 108 may not be of high thermal resistance.

The side surface 104 may be further used for precise positioning of the storage cell 100 in an energy storage system, by aligning the side surface 104 with complementary rigid components in the energy storage system. In some embodiments, the complementary component may be a thermal component in the energy storage system.

The side surface 104 can have a thickness of 0.1-2.0 mm. The side surface 104 can have a thickness of about 0.1 mm, 0.2 mm, 0.3 mm, 0.4 mm, 0.5 mm, 0.6 mm, 0.7 mm, 0.8 mm, 0.9 mm, or 1.0 mm. The side surface 104 can have a thickness of about 1.1 mm, 1.2 mm, 1.3 mm, 1.4 mm, 1.5 mm, 1.6 mm, 1.7 mm, 1.8 mm, 1.9 mm, or 2.0 mm. The side surface 104 can have a thickness of 0.05 mm A thinner side surface 104 can be used to enable higher volumetric energy density. The wall (referring to the side surface 104) may be thicker if the cell size is longer or has a longer electrode. Important factors in considering side surface thickness include mechanical strength due to fatigue over time, resistance to side rupture potentially from large hoop stress due to internal pressure, and balancing thermals to act as a parallel resistor during cooling/heating the cell.

The top surface 102 or bottom surface 106 can be comparatively thicker as compared to the side surface 104. One or more of the top surface 102 or bottom surface 106 can have a thickness of 0.1-2.0 mm. The top surface 102 or bottom surface 106 can have a thickness of about 0.1 mm, 0.2 mm, 0.3 mm, 0.4 mm, 0.5 mm, 0.6 mm, 0.7 mm, 0.8 mm, 0.9 mm, or 1.0 mm. The top surface 102 or bottom surface 106 can have a thickness of about 1.1 mm, 1.2 mm, 1.3 mm, 1.4 mm, 1.5 mm, 1.6 mm, 1.7 mm, 1.8 mm, 1.9 mm, or 2.0 mm A thicker top surface 102 or bottom surface 106 can provide additional substrate for electrical connections. A thicker top surface 102 or bottom surface 106 can be useful for stronger welds to the side surface 104 with optionally greater interconnect process windows. A thicker top surface 102 or bottom surface 106 can be useful to enable for more heat transfer away from electrical joints during normal operation of the cell, thus enabling high thermal performance capability. A thicker top surface 102 or bottom surface 106 can be useful for manufacturing for containing more of the magnetic flux from material handling or assembly equipment during cell and final product assembly. This in turn can enable the manufacture of taller cells and higher factory operation speeds.

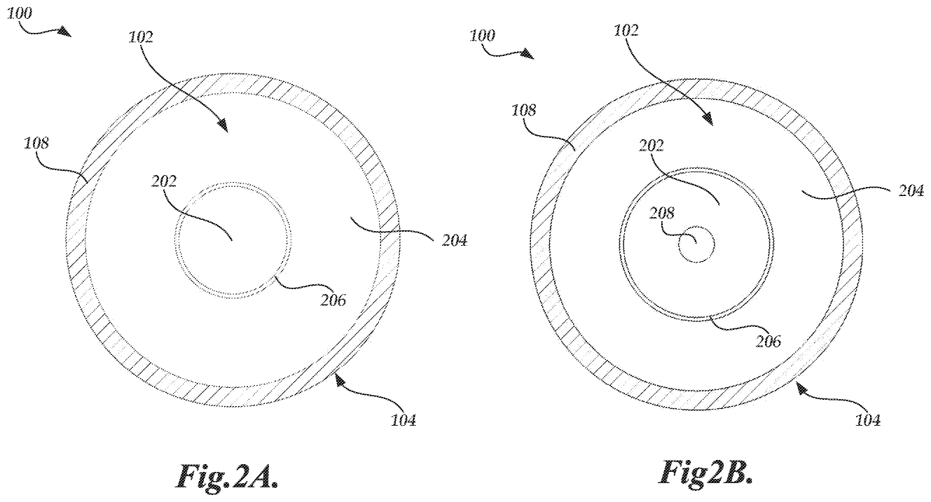

FIG. 2A illustrates the top surface 102 of the storage cell 100. The top surface 102 may comprise electrically conductive material configured as concentric positive and negative terminals, depicted as a center terminal 202 and an outer terminal 204 in FIG. 2A. The center terminal 202 and the outer terminal 204 can be marked with text, symbols, colors, geometric features and the like to allow for identification of each terminal or the boundaries of each terminal. In some embodiments, the center terminal can be surrounded by a terminal insulator gasket 206. The terminal insulator gasket 206 can act as an electrical insulator (or dielectric insulator) between the central terminal 202 and the outer terminal 204. The center terminal 202 and the outer terminal 204 can be joined with other components to deliver electrical power to other systems, subsystems, or components. The center terminal 202 and/or the outer terminal 204 can be configured externally to improve suitability as electrical contacts. Such external configurations can improve material compatibility and area and thickness available for making electrical joints with the center terminal 202 and/or the outer terminal 204.

In some embodiments, the center terminal 202 is the positive terminal and the outer terminal 204 is the negative terminal. In other embodiments, the center terminal 202 is the negative terminal and the outer terminal 204 is the positive terminal. In some embodiments, the center terminal 202 may be one solid conductive component, protruding from the top surface 102 (for example, protruding from the terminal insulator gasket 206 and/or outer terminal 204), which minimizes interference with interconnecting components at the cell array level. The center terminal 202 may also be used as a gap-setting feature for adhesives, encapsulants, or heat sinking elements. The sleeve 108 may overlap onto the outer perimeter of the top surface 102 to prevent accidental bridging of positive and negative terminals between adjacent storage cells 100 in the energy storage system, or to enforce a minimum across-surface “creepage” from conductive components at differing electrical potential, such as the cooling system or product frame.

The top surface 102 may be tailored as maximally flat and obstacle-free viable weld areas, comprising substrate thicknesses and materials suitable for granting a broad interconnect energy process window—translating to interconnect assembly gapping robustness—with minimal risk of compromising hermeticity of the storage cell 100. Sufficient positive and negative terminal area may be provided for simultaneous foil down-holding, welding area, and four-probe Kelvin interconnect verification testing on opposing sides of each terminal weld. Because all positive and negative cell terminals for the storage cells 100 are placed substantially coplanar and in a common orientation, electrical interconnects required for power delivery and voltage sensing may also run along a single plane (for example, integrated as a foil sheet). Laser-welded interconnects along the common plane of the top surfaces 102 may create electrically-conductive connections which are used to supply voltage and current with low heat loss, as well as connect voltage-sensing and controlling electronics with reduced manufacturing and operation expenditures.

In some embodiments, the top surface 102 can be made of a ferrous or magnetic material. In some embodiments, the center terminal 202 or the outer terminal 204 are made of a ferrous or magnetic material. In some embodiments, parts of the top surface 102 that are not the center terminal 202 or the outer terminal 204 include ferrous or magnetic material. Enough ferrous or magnetic material can be on the top surface 102 such that an assembly tool can be used to pick up the cell and entire battery assembly by magnetic attraction to the top surface 102.

In some embodiments, the side surface 104 can be made of the same ferrous or magnetic material as the top surface 102. Alternatively, the side surface 104 can be made of a different material. The side surface 104 can be made of a non-magnetic or non-ferrous material. The side surface 104 can be made of a lighter material (for example, aluminum).

In an illustrative embodiment, the dimensions of the circular areas presented by the center terminal 202 and the outer terminal 204 may be determined based on a threshold of statistical likelihood that a cell array-level interconnect process (for example, laser welding) will be successful. For example, in one embodiment, the threshold likelihood success may be set to 99.9999% (4 sigma) or a maximum failure rate of 0.0001 or lower. Still further, the dimensions of the circular areas presented by the center terminal 202 and the outer terminal 204 may be configured to be dependent. In one embodiment, a diameter of the center terminal 202 may be proportionally set to be one half (½) of a diameter of the outer terminal 204. In another embodiment, the flat conductive diameter of the center terminal 202 may be set roughly equal to the flat conductive radial width of the outer terminal 204. One skilled in the relevant art will appreciate that other failure rates, thresholds, dependencies or proportionality may be implemented for different storage cells, manufacturing environments, thermal system configurations, or desired cell arrays. Additionally, in the event that additional functionality is implemented on the top surface 102, such as port 208 for receiving internal materials or for making physical connections, the dimension of the center terminal 202 or outer terminal 204 may be adjusted accordingly, as illustrated in FIG. 2B, in order to statistically rebalance interconnect welding or other assembly process outcomes. In embodiments where a relatively small fraction of outer terminal 204 surface is required for electrical interconnect, the remaining area can be utilized as an interface for cell terminal temperature instrumentation.

In some embodiments, the terminal insulator gasket 206 has a small radial width (for example, 0.1 mm). The terminal insulator gasket 206 can be thin enough to satisfy electrical creepage requirements at 4.2V potential. Alternatively, the terminal insulator gasket can be configured to satisfy electrical creepage requirements at 3.0V, 3.2V, 3.4V, 3.6V, 3.8V, 4.0V, 4.4V, 4.6V, 4.8V, or 5.0V. A thin terminal insulator can be useful to maximize electrical interface area on top surface 102.

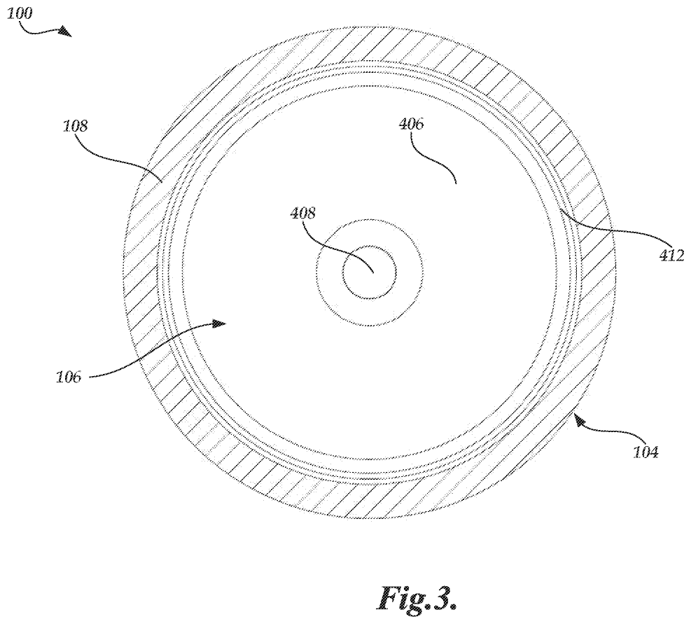

FIG. 3 illustrates the bottom surface 106 of the storage cell 100. The bottom surface 106 may integrate all storage cell features which need not be accessed or interfaced with for cell array or battery pack integration. For example, the bottom surface 106 may contain all functionality other than housing the terminals, such as, but not limited to, geometry for sealing of open side of the cell can and/or geometry for calibrated venting in thermal runaway. Integrating all non-planar, non-terminal features into the bottom surface 106 may allow the top surface 102 to reach a maximum electrical interface area, which may in turn optimize interconnect welding or other assembly process outcomes.

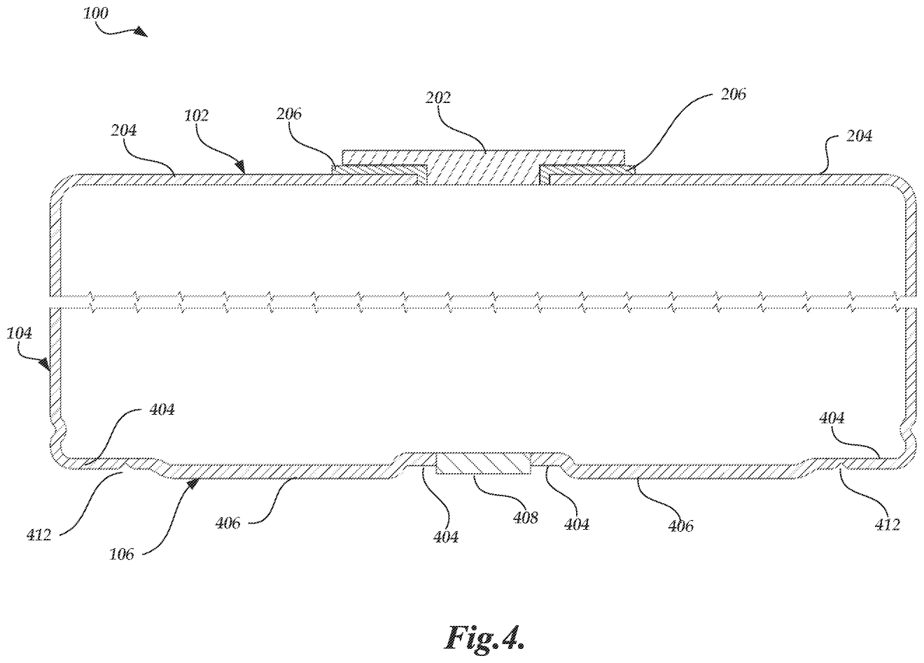

FIG. 4 shows a sectioned side view structural diagram of the top surface 102 and bottom surface 106 of the cell encasing the cell interior 410. The bottom surface can have a port 408 for receiving internal materials or for making physical connections.

In some embodiments, the bottom surface 106 has one or more recessed portions 404 and a line contact base 406. The line contact base 406 is configured to allow the cell to rest on the bottom surface 106 with stability. The line contact base 406 can be an annulus on the bottom surface 106 or substantially annulus relative to a contact surface to provide stability of the cell 100. Alternatively, the line contact base 406 can be three or more points of contact or areas on the bottom surface 106 that are configured to give stability to the cell while the cell is resting on the bottom surface 106. One of the one or more recessed portions 404 of the bottom surface 106 can be used for housing the pressure venting feature 412. One or more recessed portions 404 can be used to shroud hermetically sealing closures, or the like, on bottom surface 106, or between the bottom surface 106 and the side surface 104. One or more recessed portions 404 can be used for other purposes related to structural integrity of the cell and the bottom surface 106.

In some embodiments, the bottom surface 106 is not contiguous with the side surface 104, such that the bottom surface 106 can be installed and sealed following components internal to the cell (for example, conductors and active material). In some embodiments, the bottom surface 106 may include a port for receipt of materials for the battery cell.

Having a bottom surface 106 that is not contiguous in at least one way (for example, mechanically contiguous, materially contiguous, or any other form of contiguity or continuity) can also be advantageous for fine-tuning pressure vent characteristics, in a manner largely independent of constraints and tradeoffs presented by side surface 104 and top surface 102. This embodiment can improve cell failure scenario predictability, in particular, by directing high-temperature gas, debris, and flame away from neighboring cells, sensitive components, and product users. Additional or alternative subsequent optimizations to the pressure venting feature 412 on bottom surface 106 can further improve cell failure scenario predictability, in particular, by further directing high-temperature gas, debris, and flame away from neighboring cells, sensitive components, and product users. By steering these hazards more deterministically, the probability of propagating thermal runaway and injury can be reduced.

The perimeter of the bottom surface 106 may be recessed to accommodate some overlap in the sleeve 108 such that quality defects or thickness changes in the sleeve 108, or contour changes on the rolled or welded canister edge, do not influence cell alignment precision in the energy storage system. The configuration of the bottom surface 106 may simultaneously protect the sleeve 108 from mechanical wear and abuse from handling and conveyance during manufacturing operations and promote greater contact area between the bottom surface 106 and neighboring components, such as strength-limited adhesives.

With continued reference to FIG. 4, the center terminal 202 may comprise a solid piece of conductive material. The center terminal 202 may be separated from the outer terminal 204 via a terminal insulator gasket (for example, a compressed seal) 206. As described herein, the bottom surface 106 may have a recessed portion 404 over which the sleeve 108 may overlap. The center terminal 202 and outer terminal 204 may comprise any material suitable for laser welding and welding of internal cell structure (for example, aluminum).

In some embodiments, the conductive side surface 104 may be continuous with the outer terminal 204 and may comprise an extruded or drawn aluminum grade for improved thermal conductivity, thermal diffusivity, welding interconnect yield, and gravimetric energy density versus traditionally employed canister materials.

The disclosed energy storage cell design may be used with any internal structure suitable for energy storage devices. One example of a suitable internal design may include a first substrate, an inner separator, a second substrate, and an outer separator. The first substrate may be electrically conductive. The inner separator may be electrically insulative and disposed over (for example, stacked on top of) the first substrate. The electrically conductive second substrate may be further disposed over (for example, stacked on top of) the inner separator. The electrically insulative outer separator may be disposed over (for example, stacked on top of) the second substrate. Upon stacking the first substrate, the inner separator, the second substrate, and the outer separator in a successive manner, the first substrate, the inner separator, the second substrate, and the outer separator may be rolled about a central axis with the first substrate being closest in position to the central axis. In some embodiments, outer separator is absent. The rolled components may then be housed, along with an ion-transfer medium, within the presently disclosed cylindrical energy storage cell design.

### Illustrative Product System

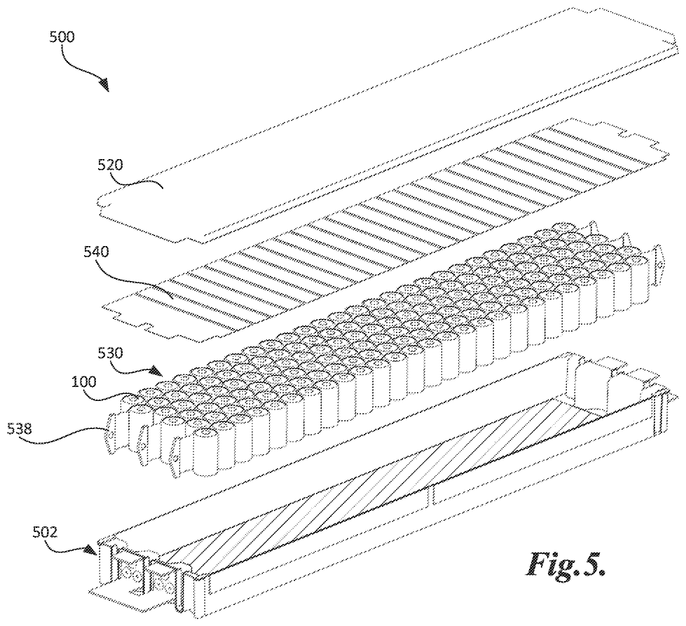

FIG. 5 illustrate an example energy storage system 500 in which storage cells 100 may be used in a cell array 530. In one embodiment, the storage cells 100 may be arranged as modules in common orientation. In other embodiments, arrays of cells may be arranged as modules in alternating or staggered orientation. In some embodiments, the storage cells 100 may have sleeves 108 and may be arranged directly adjacent to each other. In other embodiments, the storage cells 100 may not have sleeves 108 and may therefore be arranged with some distance between each cell. In some embodiments, the storage cells 100 may be electrically interconnected via a lower-side voltage brick foil sheet 540, where the foil sheet 540 is laser-welded to create an electrical connection with the cells 100, sensing electronics, and positive/negative array terminals. In other embodiments, the foil sheet 540 may be omitted entirely. The side surfaces 104 of the storage cells 100 may be cooled using a thermal component 538. The cell array may be contained within a frame structure 502 and sealed with a lid 520.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed cell assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (for example, attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. An energy cell comprising:
a circular top surface having a center terminal, an outer terminal, and a terminal insulator gasket,
wherein the center terminal and the outer terminal are configured as electrical contacts,
wherein the center terminal is encircled by the outer terminal,
wherein the center terminal and the outer terminal substantially cover the top surface,
wherein the center terminal and the outer terminal are separated by the terminal insulator gasket, wherein the terminal insulator gasket is a electrical insulator;
a side surface mechanically connected to the top surface;
a circular bottom surface mechanically connected to the side surface having an annular interface and a pressure venting feature,
wherein, the annular interface configured to form a base for the cell,
wherein the pressure venting feature is configured for venting in an opposite direction of the top surface; and
an energy storage material within the top surface, the side surface, and the bottom surface

2. The energy cell of claim 1, wherein the top surface and the side surface are contiguous.

3. The energy cell of claim 1, wherein an area of the center terminal and an area of the outer terminal are configured to be dependent.

4. The energy cell of claim 1, wherein an area of the center terminal and an area of the outer terminal are determined based on a threshold of statistical likelihood that a cell array-level interconnect welding or other assembly process will be successful.

5. An energy cell comprising:
a top surface having a center terminal and an outer terminal, wherein the center terminal and the outer terminal are configured as substantially planar electrical contacts;
a side surface mechanically connected to the top surface;
a bottom surface mechanically connected to the side surface; and
an energy storage material within the top surface, the side surface, and the bottom surface.

6. The energy cell of claim 5, wherein the top surface is substantially circular.

7. The energy cell of claim 5, wherein the center terminal and the outer terminal substantially cover the top surface.

8. The energy cell of claim 5, wherein the center terminal and the outer terminal are separated by a terminal insulator gasket, wherein the terminal insulator gasket is an electrical insulator.

9. The energy cell of claim 5, wherein the center terminal is a cathode and the outer terminal is an anode.

10. The energy cell of claim 5, wherein an area of the center terminal and an area of the outer terminal are configured to be dependent.

11. The energy cell of claim 5, wherein an area of the center terminal and an area of the outer terminal are determined based on a threshold of statistical likelihood that a cell array-level interconnect welding or other assembly process will be successful.

12. The energy cell of claim 5, further comprising a sleeve wherein the sleeve encompasses at least part of the side surface.

13. The energy cell of claim 12, the sleeve is comprised of an electrically insulating material.

14. The energy cell of claim 12, wherein the sleeve is comprised of two layers of one or more materials.

15. The energy cell of claim 5, wherein the top surface and the side surface are contiguous.

16. The energy cell of claim 5, wherein the top surface is sufficiently ferrous to allow movement via magnetic adhesion by manufacturing equipment.

17. The energy cell of claim 5, wherein the bottom surface is substantially circular.

18. The energy cell of claim 5, the bottom surface has an annular interface configured to form a base for the cell.

19. The energy cell of claim 5, wherein bottom surface has a pressure venting feature configured for venting in an opposite direction of the top surface.

20. A battery system comprising:
a plurality of cells, wherein each of the cells includes:
a top surface having a center terminal and an outer terminal, wherein the center terminal and the outer terminal are configured as electrical contacts;
a side surface mechanically connected to the top surface;
a bottom surface mechanically connected to the side surface; and
an energy storage material within the top surface, the side surface, and the bottom surface,
wherein the cells are interconnected by laser welds and aligned in a substantially planar configuration.
